(19) United States
(12) Patent Application Publication
(10) Pub. No.: US 2017/0270554 A1
(43) Pub. Date: Sep. 21, 2017

(54) ELECTRONIC COMMUNICATION NETWORK

(71) Applicant: SYNTEL, INC., Troy, MI (US)

(72) Inventors: Prachi Pramod Dandekar, Chennai Tamil Nadu (IN); Rathinavel Chandran, Chennai Tamil Nadu (IN); Dipankar Pal, Maple Grove, MN (US)

(21) Appl. No.: 15/073,855

(22) Filed: Mar. 18, 2016

(51) Int. Cl. G06Q 30/02; H04W 4/00; H04W 4/02; G06Q 30/06

(52) U.S. Cl. CPC G06Q 30/0222; G06Q 30/0601; G06Q 30/0281; G06Q 30/0224; H04W 4/008; H04W 4/02

(57) ABSTRACT

An electronic communication network may include a computer server, a customer computing device configured to communicate with the computer server, and a plurality of employee computing devices disposed at a first location and configured to communicate with at least one of the computer server and the customer computing device. The network may include a plurality of electronic beacons disposed at the first location and configured for determining a position of the customer computing device the employee computing devices. The network may be configured for providing cross sell and up sell recommendations to the customer computing device if the customer computing device is at a first location or is away from the first location. The network may include a task management system for managing in-store operational tasks for employees and employee communication devices, such as in a retail store location.

### TECHNICAL FIELD

The present disclosure relates to an electronic communications network that may be used in connection with a plurality of electronic computing devices.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

Conventional communication systems, such as those used in retail stores, often are not configured to communicate with customer computing devices and/or do not use shopper profile information in connection with interactions with customers in retail stores. Conventional systems are often not configured to for efficiently assisting customers, such as in retail stores.

There is, therefore, a need for solutions that allow for more efficient communications and/or improve the efficiency of various systems. The foregoing discussion is intended only to illustrate aspects of the present field and should not be taken as a disavowal of claim scope.

### SUMMARY

In embodiments, an electronic communication network may include a computer server, a customer computing device that may be configured to communicate with the computer server, and a plurality of employee computing devices disposed at a first location and configured to communicate with at least one of the computer server and the customer computing device. The network may include a plurality of electronic beacons disposed at the first location and that may be configured for determining a position of the customer computing device when the customer computing device is disposed in proximity to the first location. The electronic beacons may be configured for determining a position of each of the plurality of employee computing devices.

In embodiments, the computer server may be configured to communicate with the plurality of electronic beacons to determine the position of the customer computing device when the customer computing device is disposed at the first location and/or the position of each of the plurality of employee computing devices. In embodiments, the customer computing device may be configured, when the customer computing device is disposed at the first location, to send a help request message to the computer server. In embodiments, the computer server may be configured to select one of the plurality of employee computing devices for assisting a shopper associated with the customer computing device. In embodiments, the computer server may be configured to send a help instruction message to the selected employee computing device.

In embodiments, a method of communicating via an electronic communication network may include providing a computer server that may be configured to communicate with a customer computing device via the electronic communication network. In embodiments, the method may include providing a plurality of employee computing devices disposed at a first location. In embodiments, the employee computing devices may be configured to communicate, such as via the electronic communication network, with at least one of the computer server and the customer computing device. In embodiments, the method may include providing a plurality of electronic beacons disposed at the first location. In embodiments, the method may include determining, such as via at least a first one of the plurality of beacons, a position of the customer computing device when the customer computing device is disposed in proximity to the first location.

In embodiments, the method may include determining, such as via at least a second one of the plurality of electronic beacons, a position of each of the plurality of employee computing devices. In embodiments, the method may include sending, such as via the customer computing device, a help request message to the computer server. In embodiments, the method may include selecting, such as via the computer server, a selected employee computing device of the plurality of employee computing devices for assisting a shopper associated with the customer computing device. In embodiments, the method may include sending, via the computer server, a help instruction message to the selected employee computing device.

Potential aspects, features, details, utilities, and advantages of embodiments the present disclosure will be apparent from reading the following description and claims, and from reviewing the accompanying drawings.

### BRIEF DESCRIPTION OF THE DRAWINGS

FIG. 1 is a block diagram showing an embodiment of an electronic communication network in accordance with teachings of the present disclosure.

FIG. 1A is a block diagram showing an embodiment of an employee computing device of an electronic communication network in accordance with teachings of the present disclosure.

FIG. 2 is a block diagram showing an embodiment of an electronic communication network in accordance with teachings of the present disclosure.

FIG. 3 is a block diagram showing an embodiment of an electronic communication network in accordance with teachings of the present disclosure.

FIG. 4 is a flow diagram showing an embodiment of an electronic communication network in accordance with teachings of the present disclosure.

FIG. 5 is a schematic showing an embodiment of an electronic communication network in accordance with teachings of the present disclosure.

FIGS. 6, 7, and 8 are flow diagrams showing portions of embodiments of electronic communication networks in accordance with teachings of the present disclosure.

FIGS. 9A and 9B are screenshots of embodiments of a customer computing device of an electronic communication network in accordance with teachings of the present disclosure.

FIGS. 10 and 11 are flow diagrams showing portions of embodiments of electronic communication networks in accordance with teachings of the present disclosure.

FIG. 12 is a screenshot of an embodiment of a customer computing device of an electronic communication network in accordance with teachings of the present disclosure.

### DETAILED DESCRIPTION

Before proceeding to a detailed description of embodiments of the instant disclosure, a general overview of its operation will first be set forth.

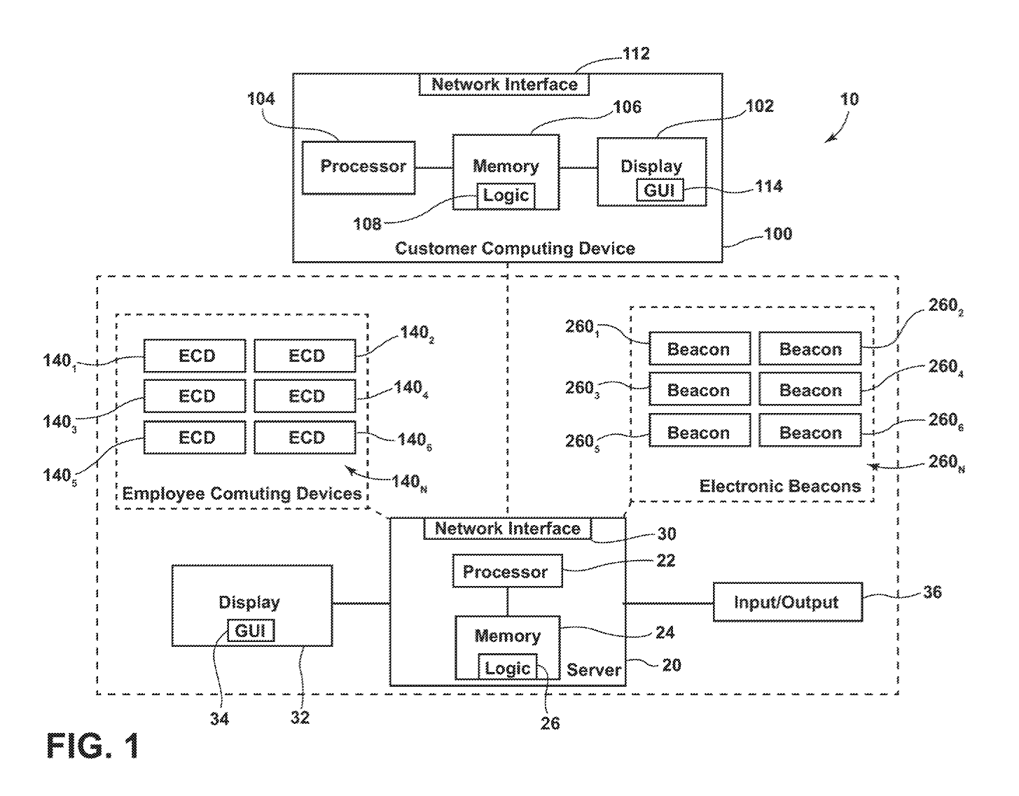

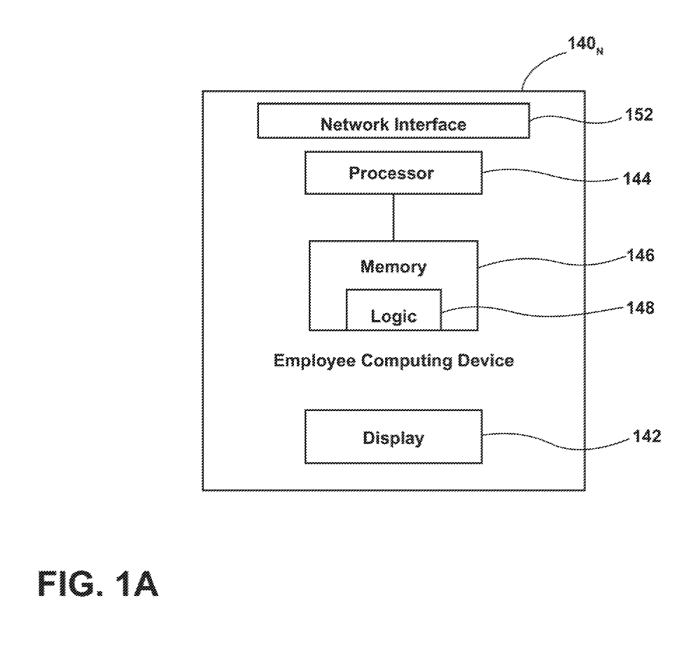

Referring now to the drawings, wherein like reference numerals are used to identify identical or similar components in the various views, FIG. 1 is a diagrammatic and block diagram view of an embodiment of an electronic communication network 10. In embodiments, network 10 may be configured for communications via an intranet (e.g., a local area network or “LAN”), a Bluetooth® network, the internet, a cellular network, other networks, and/or combinations of networks. In embodiments, electronic communication network may be used in connection with a location 12, which may include a retail store, and/or location may be referenced to herein as store 12. In embodiments, one or more of a server 20, a customer computing device 100, employee computing devices (ECDs) 140_{N}, and/or beacons 260_{N} may be included in, connected to, and/or in communication with network 10. Entities (e.g., persons) that may purchase a product or service from a store 12 may be referred to herein as customers, shoppers, and/or users.

In embodiments, network 10 may include server 20 (e.a., a computer server) and/or may include a processor 22 (e.g., an electronic processor) and a memory 24 (e.g., an electronic memory). A server logic 26 may be stored in memory 24 and may include a customer personalization module 28. Server logic 26 may include code and/or instructions that, when carried out by a processor 22 (e.g., processor), may be configured to implement one or more of the features and/or functions described here, such as, for example, in connection with customer personalization module 28. Server 20 may be connected with network 10 via a network interface 30. Server may include a display 32, a GUI 34, and/or an input/output interface 36.

In embodiments, server 20 may be configured to receive information from one of more of a variety of sources, such as, for example, from a customer computing device 100, ECDs 140_{N}, beacons 260_{N}, and/or external data sources 270. In embodiments, data received by server 20 may be in the form of messages, which may include requests. Server 20 may process requests and transmit a response. The response may include data stored, for example, in memory 24, and may be transmitted back to the source of the request and/or may be transmitted to a different destination.

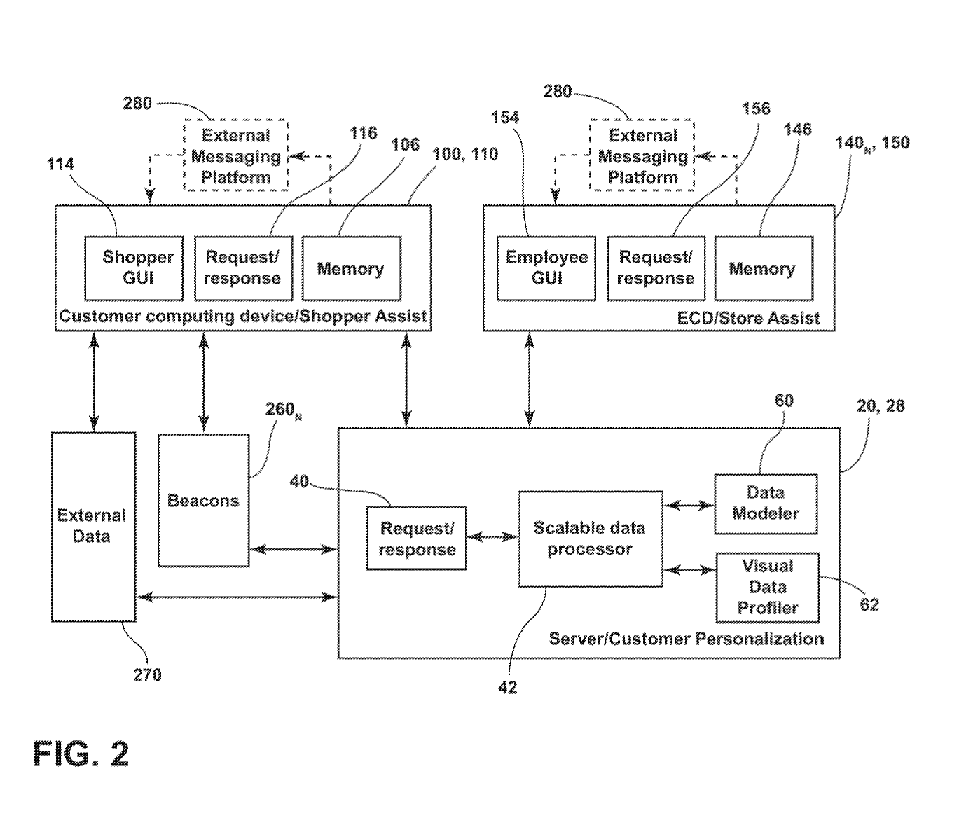

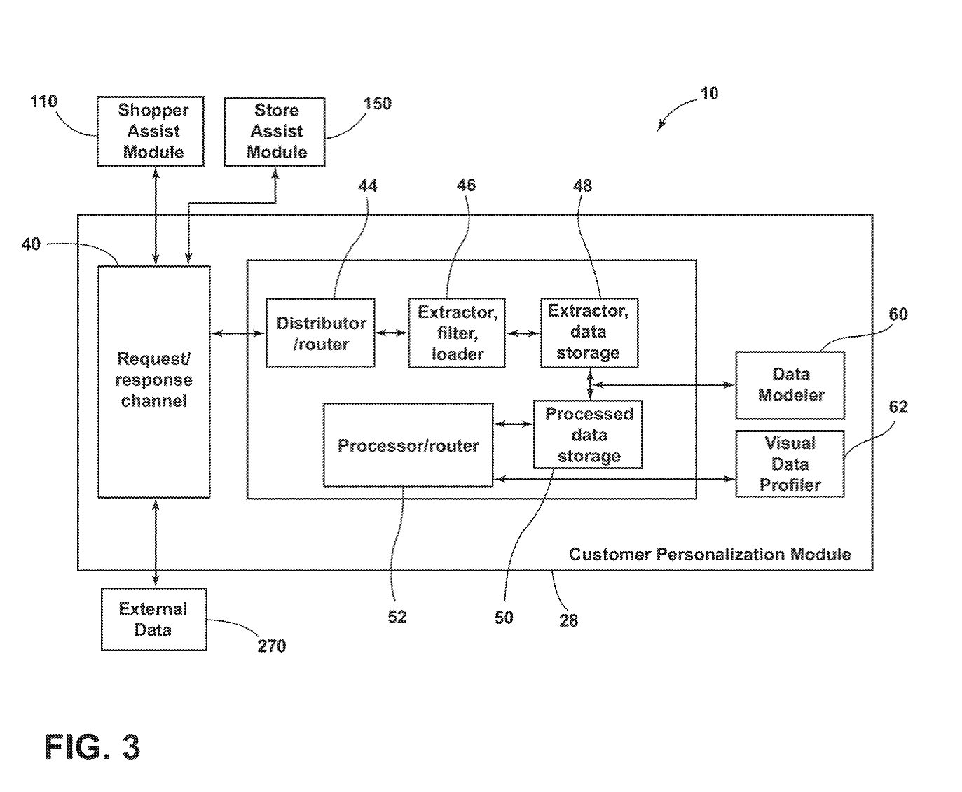

In embodiments, such as generally illustrated in FIGS. 2 and 3, server 20 may include a data request and response service channel 40, which may be configured to process transaction data (e.g., purchases by shoppers) from a store's payment system and may send processed data to trigger the next best action. The next best action may include a location and context-based cross-sell or upsell recommendations, promotions, coupons, and/or sales recommendations for a sales associate, such as described in greater detail herein.

In embodiments, server 20 may include a scalable data processor 42 that may include hardware and/or software, and that may be configured to manage shopper profiles and shopper transactional behavior (e.g., as acquired by data request and response service channel). Scalable data processor may include hardware, such as, for example, computer servers that may include high speed networking devices that may be managed via big data processing engine platforms. Scalable data processor 42 may include a data distributor/router 44 that may be configured to distribute data from the data request and response service channel 40. Scalable data processor 42 may include a data extractor, filter, and storage loader 46 that may be configured to extract, filter, and store data in storage mediums of server 20 (e.g., memories 24, 48, 50). Scalable data processor 42 may include an extracted data memory 48 and processed data memory 50, which may be configured to store extracted and processed data, respectively. In embodiments, extracted data memory 48 and processed data memory 50 may be independent components and/or may be included in server memory 24. In embodiments, scalable data processor 42 may include a data processor and router 52 that may be configured to handle requests and responses of the data processing done by server 20 and/or via customer personalization module 28.

In embodiments, server 20 may include a statistical data modeler 60 that may be configured to load and/or connect to extracted data, statistical algorithms, machine learning, and/or neural networks from data storage devices, such as, for example, extracted data memory 48. Statistical data modeler 60 may be configured to apply the extracted statistical algorithm(s) to the extracted data. The output of statistical data modeler (e.g., outputs from the statistical algorithms) may be stored in processed data memory 50.

In embodiments, server 20 may include a visual profiler 62 that may be configured to receive the output of statistical data modeler 60 (e.g., directly and/or via processed data memory 50) and may send data to be displayed on a display (e.g., customer device display 102 and/or ECD display 142).

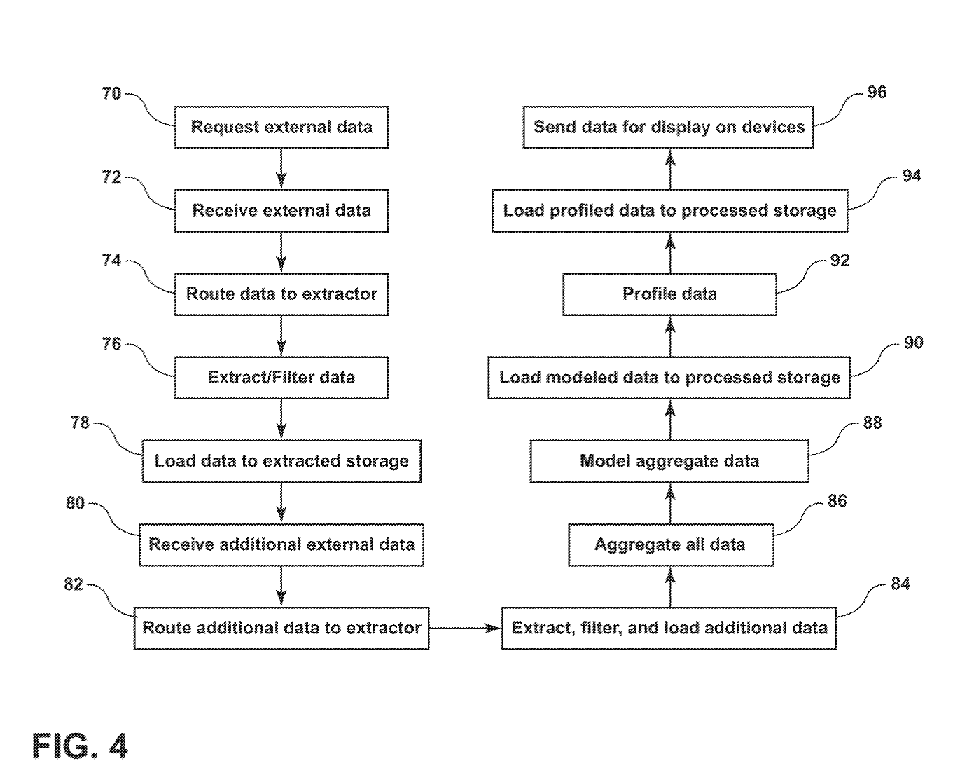

In embodiments, such as generally illustrated in FIG. 4, an initial set up of server 20 may include the data service channel initiating a batch process to request external data (e.g., retail data) in step 70. In step 72, data service channel may receive the external data and, in step 74, data router may distribute the data to data extractor/filter/loader 46. Extractor/filter/loader 46 may extract and filter the data in step 76, and may load the filtered data into extracted data memory 48 in step 78. In embodiments, data service channel 40 may receive additional external information in step 80, and the additional external information may be distributed, in step 82, to extractor/filter/loader 46. In step 84, extractor/filter/loader 46 may extract, filter, and/or load the additional external data into extracted data memory 48. In step 86, data service channel 40 may aggregate of the data loaded in extracted data memory 48. In step 88, extracted data memory 48 may trigger data modeler to pull the aggregated data from extracted data memory 48 and data modeler 60 may model the aggregated data. In step 90, the modeled aggregated data may be loaded into processed data memory 50. In step 92, visual profiler 62 may pull the aggregated data and/or the modeled aggregated data from processed data memory 50 and profile the data. In step 94, the profiled data may be loaded into processed data memory 50, and, in step 96, may be sent to customer devices 100 and/or ECDs 140_{N} for use (e.g., viewing) by shoppers and/or employees.

Referring again to FIGS. 1 and 2, in embodiments, network 10 may include customer computing device 100 (e.g., a shopper's device), which may include display 102, a processor 104, and/or a memory 106. A customer logic 108 may be stored in memory 106 and may include a shopper assist module 110. Customer logic 108 may include code and/or instructions that, when carried out by a processor (e.g., processor 104), may be configured to implement one or more of the features and/or functions described herein, such as, for example, shopper assist module 110. Customer device 100 may be connected with network 10 via a network interface 112. In embodiments, customer device 100 may comprise a mobile device and may include, for example, and without limitation, a smartphone, at personal digital assistant (PDA), a laptop computer, a tablet computer, a wearable computing device (e.g., a smart watch), an augmented reality device, a virtual reality device, and/or other computing device. In embodiments, the user of the customer device 100 (e.g., a shopper) may download shopper assist module 110 and may sign and/or log in to selectively connect to network 10, such as via shopper assist module 110. Customer logic 108 may include a request/response module 116.

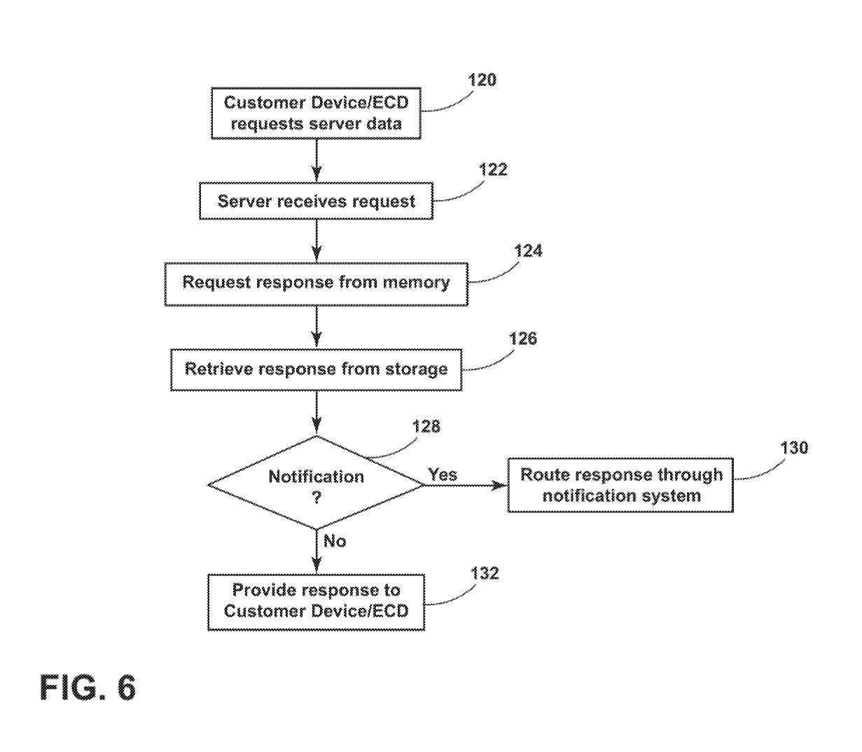

In embodiments, customer device 100 may be configured for one or more of a variety of tasks that may be carried out, at least in part, via shopper assist module 110. Customer device 100 may include a graphical user interface (GUI) 114 that may be displayed on display 102 of customer device 100 and that may be generated and/or controlled via shopper assist module 110. In embodiments, such as generally illustrated in FIG. 6, customer device 100 may be configured to communicate with server 20. In embodiments, customer device 100 may request data from server 20 in step 120, and data service channel 40 of server 20 may receive the request in step 122. In step 124, data service channel 40 may request data processor 52 to route a response from processed data memory 50, and data processor 52 may route the request to processed data memory 50. In step 126, data service channel 40 may retrieve/receive the response, which may include processed data, from the processed data memory 50 via data processor 52. In steps 128, 130, and 132, the response may be provide to the requesting customer device 100. In embodiments, the response may be in the form of a notification (e.g., a message pushed to the device 100) and/or a visual profile (e.g., information presented via GUI 114 and/or shopper assist module 110). If the response is in the form of a notification, the response may, in step 130, be routed through a notification system 280, which may be an external system, and the response may then be provided to customer device 100 in step 132. If the response is not in the form of a notification, the response may be provided directly to customer device 100.

In embodiments, customer device 100 may be configured to receive inputs from a user (e.g., a shopper). For example, and without limitation, a shopper may desire assistance from a store employee and may submit the request (e.g., a help/assist request message) via shopper assist module 110 on customer device 100, such as via one or more buttons (e.g., physical buttons and/or soft buttons displayed via GUI 114). In embodiments, customer device 100 may receive information from one or more sources, such as server 20. ECDs 140_{N}, acid or other sources, and customer device 100 may display the received information and/or corresponding information to a user via GUI 114 and/or display 102.

In embodiments, customer device 100 may include one or more operation modes. In embodiments, customer device 100 may operate in a first mode if the customer device 100 is riot in proximity to a store 12 (e.g., if the customer device 100 is at a location other than at a store location 12). In the first mode, customer device 100 may permit a shopper to create a wish list, view product information, order products, find store locations, and/or obtain other information about the store 12.

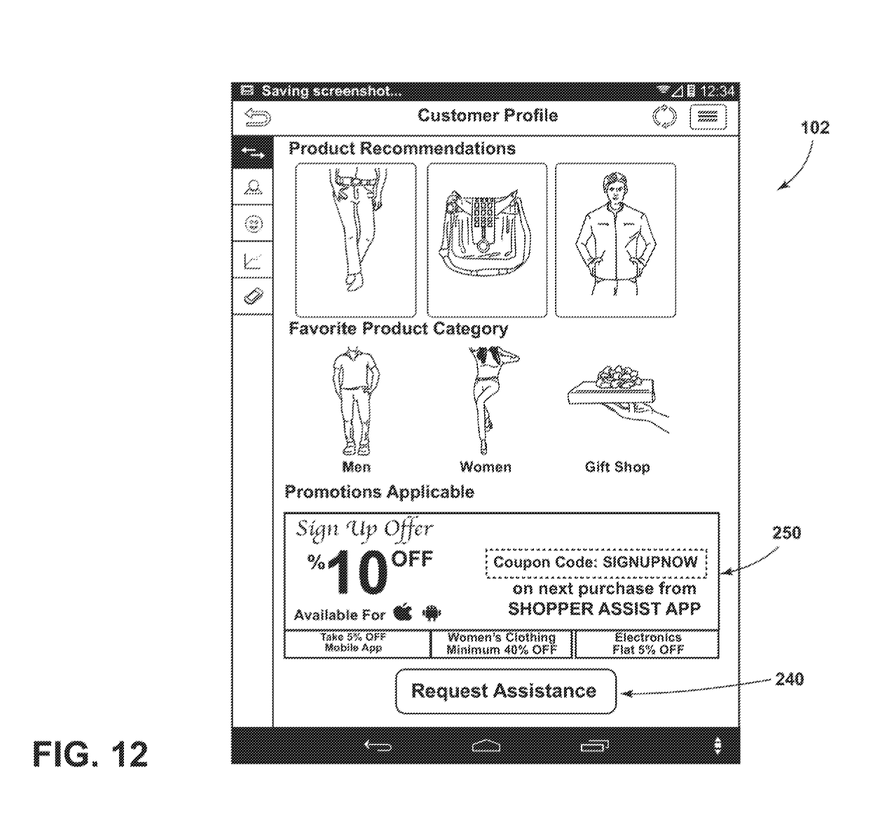

In embodiments, customer device 100 may operate in a second mode if customer device 100 is in proximity to and/or inside a store 12 (e.g., in range of one or more beacons 260_{N}). In the second mode, customer device 100 may (e.g., via shopper assist module 110) provide features to the shopper that may not be available in the first mode. For example, and without limitation, in the second mode, customer device 100 may include a button 240 (see, e.g., FIG. 12) for requesting employee assistance as described above).

In embodiments, network 10 may include one or more ECDs 140_{N}, which may include a processor 144 and/or a memory 146 (see, e.g., FIG. 1A). An employee logic 148 may be stored in memory 146 and may include a store assist module 150. Employee logic 148 may include code and/or instructions that, when carried out by a processor (e.g., processor 144), may be configured to implement one or more of the features and/or functions described herein, such as, for example, store assist module 150. ECDs 140_{N} may be connected with network 10 via a network interface 152 and/or may be configured to communicate with server 20 and/or customer computing device 100. In embodiments, ECDs 140_{N} may comprise mobile devices and may include, for example, a smartphone, a personal digital assistant (PDA), a laptop computer, a tablet computer, a wearable computing device (e.g., a smart watch), an augmented reality device, a virtual reality device, and/or other computing device. Employee logic 148 may include a request/response module 156.

In embodiments, ECDs 140_{N} may be configured for one or more of a variety of tasks that may be carried out and/or controlled, at least in part, via store assist module 150. An ECD 14)_{N} may include a graphical user interface (GUI) 154 that may be displayed on display 142 of the ECD 140_{N} and that may be generated and/or controlled via store assist module 150, ECDs 140_{N} may be configured to receive messages from one or more sources, such as server 20, other ECDs 140_{N}, customer device 100 (e.g., a help request message), and/or other sources. In embodiments, server 20 may select an employee to assist a shopper and server 20 may transmit the instruction message to the employee's ECD 140_{N}. The employee's ECD 140_{N} may then display the instruction message and/or information relating to the message via GUI 154 and/or display 142. In embodiments, ECDs 140_{N} may be configured to interact with server 20 in the same and/or a similar manner as customer device 100, such as described in connection with FIG. 6.

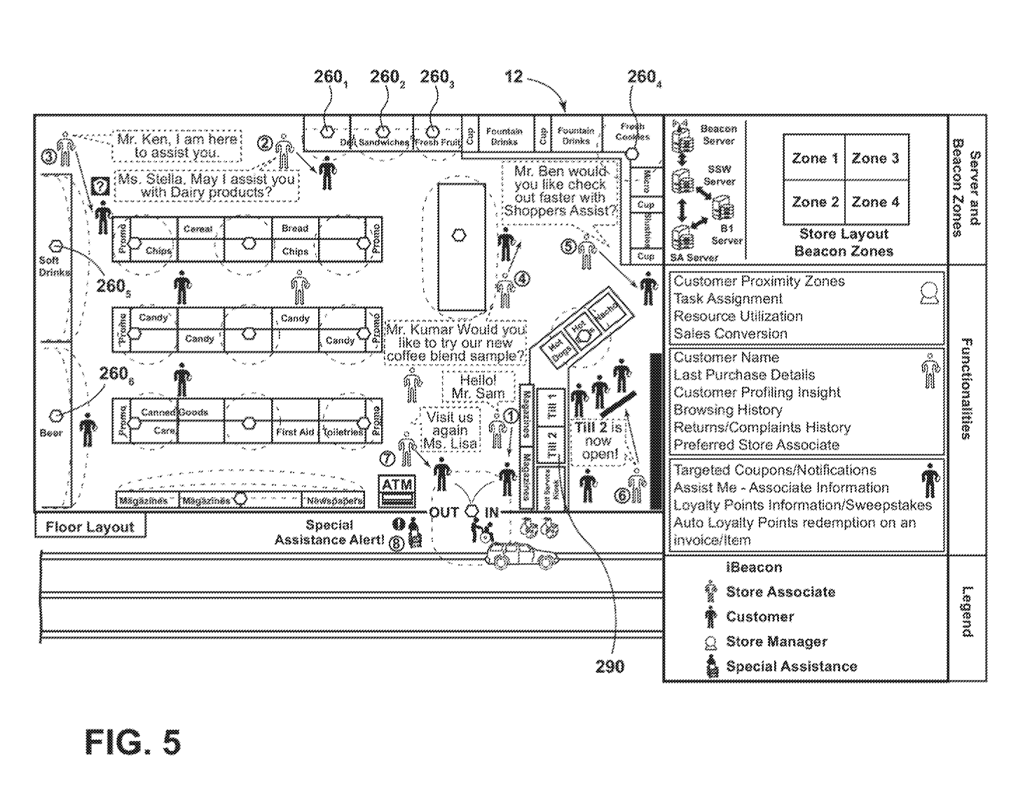

In embodiments, such as generally illustrated in FIGS. 1, 2, and 5, network 10 may include one or more electronic positioning devices 260_{N}, which may be referred to herein as beacons 260_{N}. In embodiments, beacons 260_{N} may be configured to communicate with customer computing devices 100, employee computing, devices 140_{N}, and/or server 20, such as, for example, via Bluetooth® low energy. In embodiments, beacons 260_{N} may be configured for determining the position of customer computing devices 100 and/or ECDs 140_{N}.

In embodiments, a beacon 260_{N} may be configured to determine positions in isolation (e.g., independently from other beacons). Additionally or alternatively, a plurality of beacons 260_{N} may cooperate/communicate with each other and/or with server 20 to determine positioning (e.g., beacons may triangulate positions of customer devices 100 and/or ECDs 140_{N}). In embodiments, beacons 260 may be configured to transmit information regarding the current position of a customer device 100 and/or an ECD 140_{N}. The transmitted information may include the current position and/or may include information from which the current position may be derived. For example, and without limitation, beacons 260_{N} may transmit a current position, which may then be used by customer device 100, an ECD 140_{N}, and/or server 20. Additionally or alternatively, beacons 260_{N} may transmit information that may be used by customer device 100, ECD 140_{N}, and/or server 20 to determine the current position of the customer device 100 (e.g., distances from each of three or more beacons). In embodiments, a position (e.g., of a customer device 100 and/or ECD 140_{N}) may be determined, for example, according to a grid system that may cover some or all of the store 12, such that positions may be particular segments of the grid. In embodiments, current positions may be determined to be the known position of the nearest beacon 260_{N}.

In embodiments, server 20 may include one or more shopper profiles that may each be associated with a respective shopper and/ or that shopper's computing device or computing devices 100. A shopper profile may include information about one or more of demographics, spending propensity (e.g., spending rate according to linear regression of previous transactions), primary segment, brand loyalty, spending capacity (e.g., a periodic average of dollars spent on all past transactions), wallet size, purchase behavior, churn score, conversion rating, purchase consideration, business consideration, basket size (e.g., average amount spent per purchase), customer duration (e.g., length of time shopper has been customer), lifetime value (e.g., total dollars spent) and/or other information about a shopper. In embodiments, a churn score may be determined according to one or more of a variety of factors, including demographic information, transaction history, browsing history, the amount of time between a customer's first order and the most recent recorded action, a customer's in-store behavior, an average time between transactions for an average customer. In embodiments, a conversion rating may be determined according to the amount of time between when a customer initially showed an intent to purchase a product. (e.g., viewed and/or requested additional details about the product) until the customer actually purchased the product. In embodiments, brand loyalty rating may be determined according to how much a customer spends on a particular brand, how often a customer purchases products of the brand, and/or how recently the customer purchased a product of the brand. In embodiments, primary segments may be determined according to the purchase history of a customer. In embodiments, customers may be segmented according to transactional information, demographic information, browsing history (e.g., online), customer trail in a store (e.g., as tracked by beacons), social media data, and/or other customer-related data. For example, and without limitation, customers that have exhibited a pattern of increasing the amount spent on a particular brand, have an above average basket size, and/or purchase a variety of products may be assigned to a gold segment. Customers with lower basket sizes, less purchasing diversity, and/or less significant patterns of increased purchases may be assigned to a silver segment. In embodiments, purchase consideration may correspond to a set of products that are likely to be purchased next by a customer. The set of products may be determined according to a group that the customer may be belong to and products purchased by members of that group and/or of a similar group that have made similar previous purchases and the customer. Customer groups may be determined via demographic information. In embodiments, business consideration may correspond to a company's general practice of focusing on customers that generate the most revenue, which may be determined according to grouping and/or segmenting.

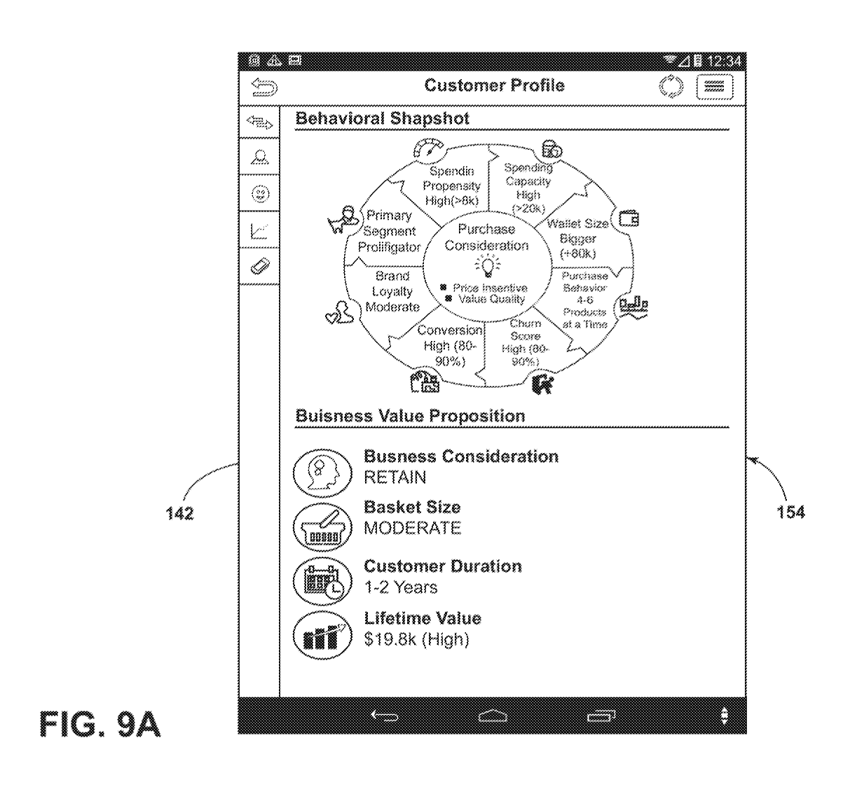

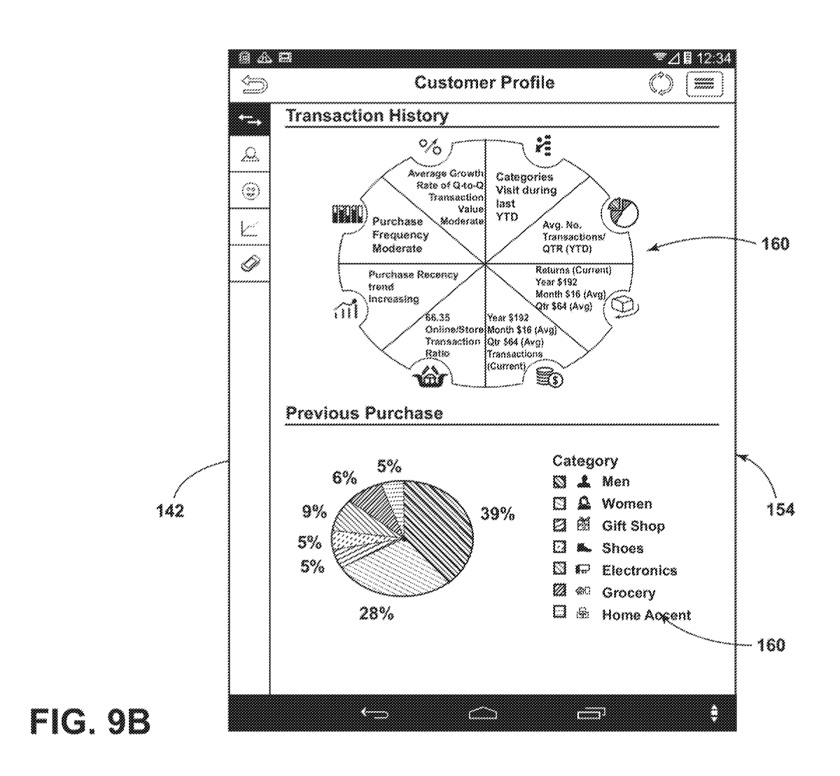

In embodiments, such as generally illustrated in FIGS. 9A and 9B, ECDs 140_{N} (anchor a customer computing device 100) may be configured to receive profile information about a shopper from server 20 and display the profile information via GUI 154 on display 142 of the ECD 140_{N}. For example, and without limitation, store assist module 150 may be configured to display profile information in one or more charts and/or graphs 160, such as pie charts, bar graphs, circular charts, line charts, and/or others. Profile information may permit an employee to better assist the shopper who requested assistance and/or may permit an employee to promote products and/or services that the shopper may be interested in. For example, and without limitation, profile information may include that a shopper purchased a product several years ago and the original warranty is about to expire. The employee may be able to view such information on the employee's ECD 140_{N} and suggest that the shopper purchase an extended warranty. In embodiments, profile information may permit an employee to cross-sell/upsell and/or more effectively cross-upsell by, for example, by providing information/recommendations about products that the shopper is likely to be interested (e.g., according to the shopper's segment, group, transaction history, etc.).

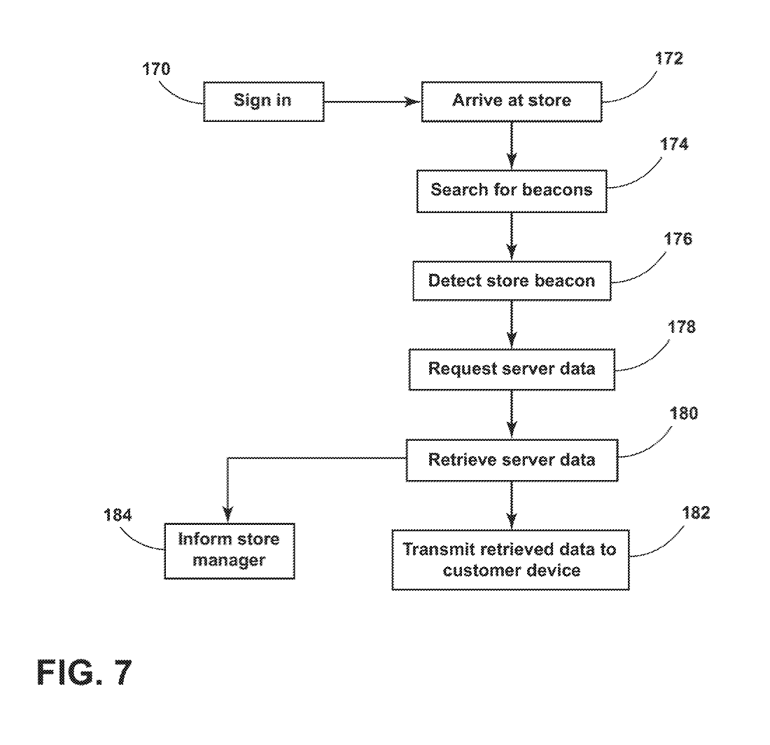

In embodiments, such as generally illustrated in FIG. 7, network 10 may be configured to automatically detect the presence of and identify a shopper that has entered a store 12. In step 170, a shopper may connect to network 10, such as via signing in and/or logging in to shopper assist module 110. In step 172, the shopper may arrive at the store 12, and, in step 174, shopper assist module 110 may cause the shopper's computing device 100 to search for beacons 260_{N}. If a beacon 260_{N} is detected (e.g., in step 176), customer device 100 may automatically request data from server 20 in step 178. The requested data may be retrieved in step 180, which may include the same or similar process as described in connection with FIG. 6. The retrieved data may then be presented to the shopper in step 182. For example, and without limitation, customer device 100 may request shopper profile data from server 20, which may then be used to generate a personalized welcome message and/or notification for displaying to the shopper (e.g., via GUI 114 on display 102). In embodiments, the retrieved data may be provided to one or more ECDs 140_{N} in step 184, such as, an ECD 140_{N} of store manager, which may inform the store manager of the arrival of the shopper and of the shopper's profile.

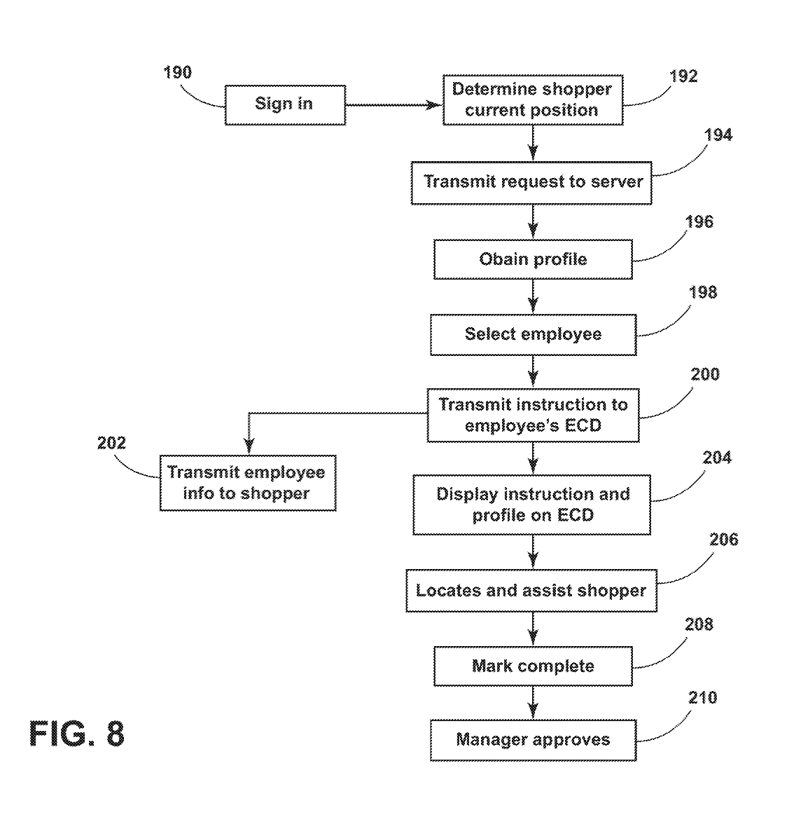

In embodiments, such as generally illustrated in FIG. 8, network 10 may be configured to provide assistance to a shopper upon request. In embodiments, a shopper may, in step 190, request assistance via customer device 100, such as via a “Request Assistance” button 240 of GUI 114, (see., e.g., FIG. 12). Customer device 100 may transmit an assistance request message to server 20 in step 194. In embodiments, the assistance request may include information regarding the current position of the shopper, which may be obtained in step 192 via beacons 260_{N}. In step 196, customer device may transmit the request to server and, in step, server may process the request (e.g., in a similar or the same manner illustrated in FIG. 6), which may include obtaining information from the shopper's profile. In step 198, server 20 may select an employee for assisting the shopper. Once an employee is selected, server 20 may, in step 200, transmit an instruction message to the employee's ECD that may instruct the employee to assist the shopper. In embodiments, the instruction message may include the shopper's position, which may allow the employee to locate the shopper efficiently. In embodiments, server may transmit, in step 202, information about the selected employee to the shopper's device. The employee information may include, for example, an estimated time of arrival, the employee's name, a picture of the employee, and/or other information about the employee. In steps 204 and 206 the instruction and profile may be displayed on the employee's ECD and the employee may locate and assist the shopper. Once the employee has finished assisting the shopper, the employee may, in step 208, indicate that assistance is complete via the employee's ECD 140_{N}, which may automatically generate an assistance complete message. In embodiments, the assistance complete message may be transmitted by ECD to server and/or the ECD of a manager. In step 210, the manager may review the assistance complete message and approve completion.

In embodiments, each employee (and the employee's ECD 140_{N}) may be associated with an expertise category. Each expertise category may include a plurality of products offered fir sale in a store 12. In embodiments, server 20 may select an employee according to the expertise categories. For example, and without limitation, server 20 may select an ECD 140_{N} with the expertise category that includes products near the current position of the shopper.

In embodiments, server 20 may include a ranking of ECDs 140_{N} that are preferred by shoppers (and their associated customer device 100). In embodiments, server 20 may select an ECD 140_{N} according to the ranking of preferred ECDs 140_{N}. For example, and without limitation, server 20 may select an ECD 140_{N} that is highest ranked for the shopper/customer device 100 (e.g., a preferred ECD 140_{N}).

In embodiments, server 20 and/or beacons 260_{N} may be configured to determine the position of each ECD 140_{N} and may select an employee to assist a shopper according to that employee's position in the store 12 and/or proximity to the shopper. For example, and without limitation, server 20 select the employee that is closest to the shopper.

In embodiments, server 20 may select an employee according to the requesting shopper's profile. For example, if the requesting shopper is associated with high value customer segment, server may select an employee with a high rating (e.g., as determined via previous customer feedback, manager feedback, etc.).

In embodiments, an instruction message provided to an ECD 140_{N} may include profile information about the requesting shopper. The profile information may include products that the shopper is likely to be interested in and presenting such products to the employee on the employee's ECD 140_{N} may allow the selected employee to suggest purchasing such products to the shopper.

In embodiments, an employee may be selected by another employee (e.g., a manager via that other employee's ECD 140_{N}, instead of by server 20. In embodiments, network 10 may be configured to operate in a manual mode in which employee selections are made by another employee and/or operate in an automatic mode in which employee selections are made by server 20.

In embodiments, server 20 may select an ECD according to a plurality of factors, such as, for example, expertise, preference ranking, and/or proximity.

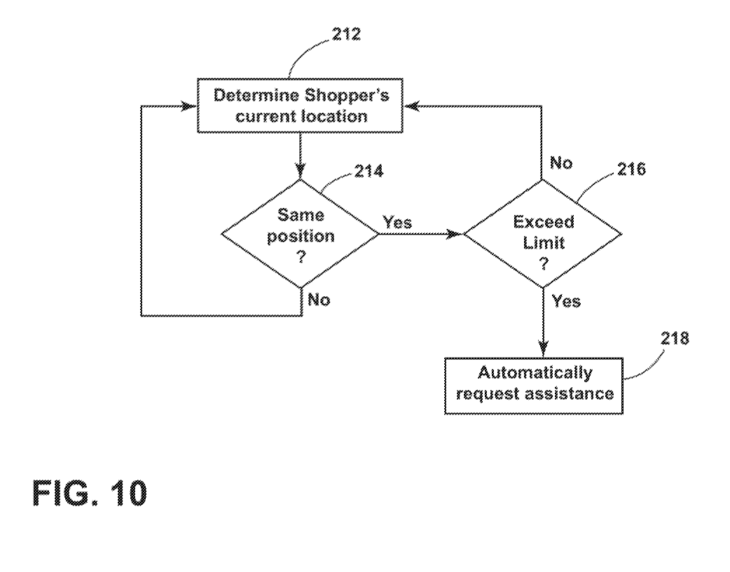

In embodiments, such as generally illustrated in FIG. 10, network 10 may monitor and/or track the amount of time that a shopper is located at a particular position in steps 212, 214, and 216. If the amount of time exceeds a predetermined threshold/limit (e.g., 5 minutes), server 20 may, in step 218 automatically (e.g., without an assistance request from the shopper or other human interaction) select an employee and send an instruction message to the employee's ECD 140.

In embodiments, the amount of time a shopper spends in a particular position may be logged in server 20. Server 20 may compile a history of shopper actions and determine what products are of most interest to the shopper according to the amount of time the shopper spends near certain products. The products determined to be of most interest to a shopper may be added/listed in the shopper's profile, which may permit an employee to ask the shopper if the shopper has any questions about those products.

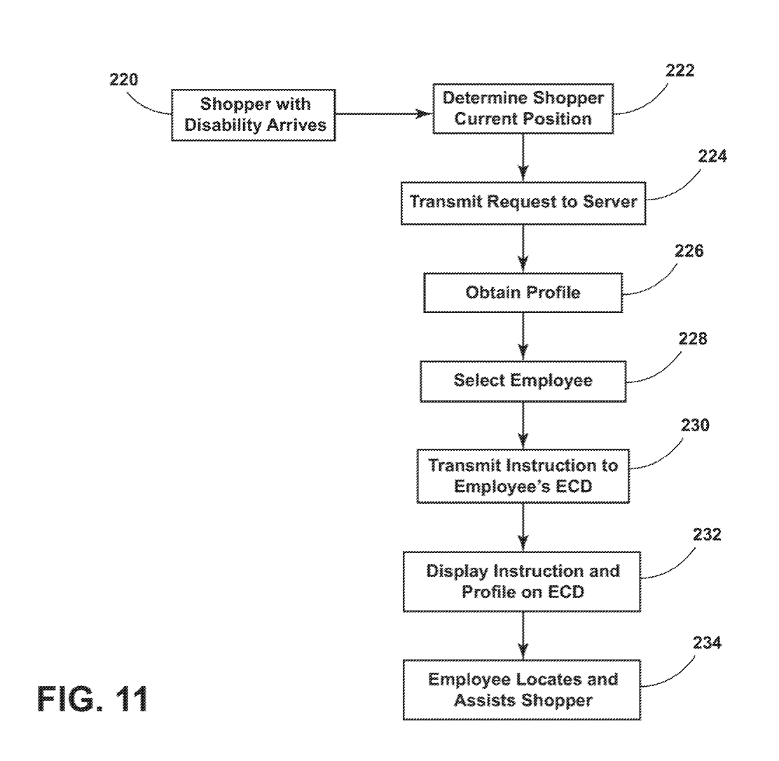

In embodiments, such as generally illustrated in FIG. 11, network 10 may be configured to provide an automatic notification if a shopper needs additional assistance. For example, and without limitation, customer computing device 100 and/or shopper assist module 110 may be configured to receive an input from a user that the user has a disability and would like additional assistance when shopping. When the user with a disability arrives at the store 12 in step 220 (e.g., comes within range of one or more beacons 260_{N}), the user's computing device 100 may, in steps 222 and 224, automatically determine the shopper's current position (e.g., via beacons 260_{N}) and send a message to the server 20 and/or an ECD 140_{N}. In steps 226, 228, and 230, server 20 may obtain the shopper's profile, select an employee to assist the user, and transmit an instruction message to the selected employee's ECD 140_{N}. In steps 232 and 234, the instruction and profile may be displayed on the selected employee's ECD 140_{N} and the employee may locate and assist the shopper. The user's indication that they would like additional assistance when shopping may be maintained for multiple visits to the store and/or until the user indicates that the user no longer wants additional assistance automatically.

In embodiments, such as generally illustrated in FIG. 12, network 10 may be configured to automatically present messages and/or notifications to a shopper on the shopper's device 100 according to the shopper's position. For example, if a shopper spends time near a product (e.g., as determined via nearby beacons 260_{N}), server 20 may automatically send information about that product to the user's device 100 and the information may be displayed on display 102 of the device 100. In embodiments, the information may include a coupon 250 for the product. The customer device 100 may permit the shopper to accept the coupon 250 and/or the coupon 250 may automatically associated with the shopper for future use. For example, and without limitation, server 20 may send a coupon 250 to a customer device 100 if the shopper spends more than a predetermined amount of time near a product, and the coupon 250 may be associated with the shopper.

In embodiments, a shopper's profile may be automatically accessed during checkout. In embodiments, ECDs 140_{N} may be configured for checking out and/or point of sale terminal (POS) devices 290 may be configured to automatically obtain a shopper's profile. In embodiments, an employee's ECD 140_{N} may have already received the shopper's profile (e.g., via an instruction message), and/or one or more beacons 260_{N} may be associated with PUS devices 290. Server 20 may be configured to automatically transmit a shopper's profile to a POS device 290 when the shopper comes within range of the beacon 260_{N} (e.g., when the shopper reaches the checkout counter). In embodiments, automatically loading a shopper's profile may eliminate the process of using/obtaining the shopper's phone number, loyalty card, or other identification, which may expedite the checkout process. In embodiments, automatically obtaining a shopper's profile may permit automatically applying coupons 250 associated with the shopper (e.g., coupons received for spending time near a product in the store 12).

In embodiments, network 10 may be configured to provide alternative options if a product desired by a shopper is not immediately available in the store 12. In embodiments, if a shopper spends a predetermined amount of time near the position of an out-of-stock product, server 20 may automatically send information to the shopper's device 100 regarding alternative purchasing options. Alternative purchasing options may include ordering the product (e.g., from a warehouse, from another store, etc.) and/or may include other similar/competing products.

In embodiments, network 10 may be configured to allow a shopper to create a wish list. For example, and without limitation, a shopper may be configured to create a wish list of products via the shopper's device 100. The wish list may be stored on the shopper's device 100 and/or on server 20. In embodiments, if a shopper with a wish list enters a store 12, server 20 may automatically generate a notification message to inform an employee (e.g., a manager) and/or may automatically transmit an instruction message to an ECD 140_{N} for an employee to offer the shopper assistance with the product(s) on the wish list. If one or more products on the wish list are not in stock, server 20 may automatically provide alternative purchasing options to the shopper's device and/or to the ECD 140_{N} of the selected employee.

In embodiments, a processor (e.g., processors 22, 104, 144) may include one or more programmable processors, microprocessors, and/or microcontrollers. In addition, processor 14 may include a central processing unit (CPU), memory (in addition to or such as the illustrated memory) and an input/output (I/O) interface through which processor may receive a plurality of input electrical signals including signals, such as generated via a graphical user interface (GUI) and/or other input/output devices. Such an I/O interface may also be configured to generate a plurality of output signals including those used to control and/or provide data to display device (e.g., displays 32, 102, 142).

It should be understood that a processor (e.g., processors 22, 104, 144) as described herein may include a conventional processing apparatus known in the art, capable of executing preprogrammed instructions stored in an associated memory, all performing in accordance with the functionality described herein. To the extent that the methods described herein are embodied in software, the resulting software can be stored in an associated memory, such as memory 24, 48, 50, 106, and/or 146, and can also constitute the means for performing such methods. Such a system or processor may further be of the type having both ROM, RAM, a combination of non-volatile and volatile (modifiable) memory so that any software may be stored and yet allow storage and processing of dynamically produced data and/or signals.

In embodiments, a memory (e.g., memory 24, 48, 50, 106, and/or 146) may be configured for storage of data, instructions, and/or code (e.g., server logic 26, customer logic 108, and/or employee logic 148) and is coupled to at least a corresponding processor (. Memory may include various forms of non-volatile (e.g., non-transitory) memory including flash memory, read only memory (ROM) including various forms of programmable read only memory (e.g., PROM, EPROM, EEPROM) and/or volatile memory such as random access memory (RAM) including static random access memory (SRAM), dynamic random access memory (DRAM), and/or synchronous dynamic random access memory (SDRAM). Although memories and processors may illustrated as a separate components, it should be understood that, in embodiments, a memory may be internal to a processor.

Display devices (e.g., displays 32, 102, 142) may be configured to display aspects of GUIs, which may be generated by the operation of logic (e.g., logic 26, 118, 148). Display devices may function as input/output devices, such as for a user of network 10 (e.g., a shopper) and may include components known in the art. Display devices may he, for example only, a liquid crystal display or light emitting diode display or other technologies known in the art. Display devices may function as only an output device with input received through other I/O devices (e.g., I/O devices) such as a keyboard or mouse (not shown). Alternatively, display devices may also function as an input device and may include a touch screen display including, for example, capacitive and/or resistive touch screen displays, and/or other technologies known in the art.

It should be farther understood that an article of manufacture in accordance with this disclosure includes a non-transitory computer-readable storage medium (e.g., memory 24, 48, 50, 106, and/or 146) having a computer program encoded thereon for implementing logic and other functionality described herein. The computer program may include code to perform one or more of the methods disclosed herein. Such embodiments may be configured to execute on one or more processors, multiple processors that are integrated into a single system or are distributed over and connected together through a communications network, and/or where the network may be wired or wireless. Code for implementing logic may, when executed by a processor, cause a plurality of transistors to change from a first state to a second state. A specific pattern of change (e.g., which transistors change state and which transistors do not), may be dictated, at least partially, by the logic and/or code. For example, and without limitation, in embodiments, processor of system may include a plurality of transistors that change state according to logic and/or code that implements logic.

In embodiments, the term “module” includes an identifiable portion of computer code, computational instructions, executable instructions, data, and/or a computational object to achieve a particular function, operation, processing, and/or procedure. A module may be implemented via software, hardware/circuitry, or a combination of software and hardware. A module, for example, may comprise one or more physical or logical blocks of computer instructions that may, for instance, be organized as an object, procedure, or function. In embodiments, executables of a module may not be physically located together and/or may include disparate instructions stored in different locations which, when joined logically together, may comprise the module and/or achieve the stated purpose for the module. In embodiments, a module may include a single instruction, many instructions, and/or may be distributed over several different code segments, among different programs, and/or across several memory devices. In embodiments, modules may represent data and may be embodied in any suitable form and/or may be organized within any suitable type of data structure. The represented data may be collected as a single data set and/or may be distributed over different locations, such as different storage /memory devices.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “communicate” and “communication” are meant to be construed broadly to encompass both wired and wireless connections and communications. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure as defined in the appended claims.

Any element in a claim that does not explicitly state “means for” performing a specified function, or “step for” performing a specific function, is not to be interpreted as a “means” or “step” clause as specified in 35 U.S.C. § 112, ¶6 (pre-AIA) or 35 U.S.C. §112(f) (AIA). In particular, the use of “step of” in the claims is not intended to invoke the provisions of 35 U.S.C. §112, ¶6 (pre-AIA) or 35 U.S.C. §112(f) (AIA),

What is claimed is:

1. An electronic communication network, comprising:
a computer server;
a customer computing device configured to communicate with the computer server;
a plurality of employee computing devices disposed at a first location and configured to communicate with at least one of the computer server and the customer computing device;
a plurality of electronic beacons disposed at the first location and configured for determining a position of the customer computing device when the customer computing device is disposed in proximity to the first location, and configured for determining a position of each of the plurality of employee computing devices;
wherein the computer server is configured to communicate with the plurality of electronic beacons to determine the position of the customer computing device when the customer computing device is disposed at the first location and the position of each of the plurality of employee computing devices;
wherein the customer computing device is configured, when the customer computing device is disposed at the first location, to send a help request message to the computer server; the computer server is configured to select one of the plurality of employee computing devices for assisting a shopper associated with the customer computing device; and the computer server is configured to send a help instruction message to the selected employee computing device.

2. The electronic communication network of claim 1, wherein each employee computing device is assigned to at least one of a plurality of expertise categories; the help request message includes a current position of the customer computing device; each possible position of the customer computing device is associated with one of the expertise categories; and the selected employee computing device is assigned to the expertise category associated with the current position of the customer computing device.

3. The electronic communication network of claim 1, wherein the computer server includes a ranking of preferred employee computing devices for the customer computing device, and the computer server is configured to select the selected employee computing device according to the ranking.

4. The electronic communication network of claim 1, wherein the customer computing device is configured to automatically generate and transmit the help request message if a current position of the customer computing device does not change for a predetermined amount of time.

5. The electronic communication network of claim 1, wherein the customer computing device is configured to communicate with the plurality of electronic beacons via Bluetooth low energy.

6. The electronic communication network of claim 1, wherein the selected employee computing device is configured to communicate with the plurality of electronic beacons via Bluetooth low energy.

7. The electronic communication network of claim 1, wherein the computer server includes a shopper profile associated with the customer computing device.

8. The electronic communication network of claim 7, wherein the shopper profile includes a spending propensity, a primary segment, a loyalty rating, a spending capacity, a purchasing behavior, a churn score, and a conversion rating.

9. The electronic communication network of claim 1, wherein the computer server is configured to select one of the plurality of employee computing devices according to a proximity of the selected employee computing device.

10. A method of communicating via an electronic communication network, the method comprising:
providing a computer server configured to communicate with a customer computing device via the electronic communication network;
providing a plurality of employee computing devices disposed at a first location and configured to communicate, via the electronic communication network, with at least one of the computer server and the customer computing device;
providing a plurality of electronic beacons disposed at the first location;
determining, via at least a first one of the plurality of beacons, a position of the customer computing device when the customer computing device is disposed in proximity to the first location,
determining, via at least a second one of the plurality of electronic beacons, a position of each of the plurality of employee computing devices;
sending, via the customer computing device, a help request message to the computer server:
selecting, via the computer server, a selected employee computing device of the plurality of employee computing devices for assisting a shopper associated with the customer computing device;
sending, via the computer server, a help instruction message to the selected employee computing device.

11. The method of claim 10, wherein each employee computing device is assigned to at least one of a plurality of expertise categories.

12. The method of claim 10, wherein the help request message includes the position of the customer computing device.

13. The method of claim 11, wherein each possible position of the customer computing device is associated with one of the expertise categories; and the selected employee computing device is assigned to the expertise category associated with the customer computing device.

14. The method of claim 10, wherein the computer server includes a ranking of preferred employee computing devices for the customer computing device, and selecting the selected employee computing device includes selecting the selected employee computing device according to the ranking.

15. The method of claim 10, comprising, via the customer computing device, automatically generating and transmitting the help request message if the position of the customer computing device does not change for a predetermined amount of time.

16. The method of claim 10, wherein the customer computing device is configured to communicate with the plurality of electronic beacons via Bluetooth low energy.

17. The method of claim 10, wherein the selected employee computing device is configured to communicate with the plurality of electronic beacons via Bluetooth low energy.

18. The method of claim 10, wherein the computer server includes a shopper profile associated with the customer computing device.

19. The method of claim 18, wherein the shopper profile includes a spending propensity, a primary segment, a loyalty rating, a spending capacity, a spending behavior, a churn score, and a conversion rating.

20. The method of claim 19, comprising automatically applying a coupon associated with the shopper profile.
